(19) United States
(12) Patent Application Publication
(10) Pub. No.: US 2003/0174157 A1
(43) Pub. Date: Sep. 18, 2003

(54) User interface for partitioning

(76) Inventor: Olof Hellman, Bothell, WA (US)

Correspondence Address: Richard T. Black, Esq., BLACK LOWE & GRAHAM PLLC, 816 Second Avenue, Seattle, WA, 98104, US

(21) Appl. No.: 10/389,019

(22) Filed: Mar. 14, 2003

Related U.S. Application Data
(60) Provisional application No. 60/364,817, filed on Mar. 15, 2002.

(51) Int. Cl. G09G 5/00

(52) U.S. Cl. 345/700

(57) ABSTRACT

A computer-based graphical user interface for partitioning a product. The graphical user interface includes a total element indicator for indicating the total amount of elements for the product and a portioning section including one or more sections. Each section includes an indicator for indicating the element size of the section and a control. The control allows a user to select the number of corresponding sections based on the indicated total amount of elements and other control positions.

This application claims priority to, and incorporates by reference, U.S. Provisional Application Serial No. 60/364,817, entitled USER INTERFACE FOR PARTITIONING, filed Mar. 15, 2002.

### FIELD OF THE INVENTION

This invention relates generally to computer software and, more specifically, to user interfaces for software used for solving partitioning problems.

### BACKGROUND OF THE INVENTION

There is a set of problems in mathematics and set theory called partition problems. Partition problems deal with the combinatorics of dividing a Set of N elements among multiple partitions of possible sizes D1, D2, D3, etc. Dividing in this way is called partitioning.

A classic example of this sort of problem asks about partitioning a certain amount of money among the denominations of common coins: For example, 12 cents can be partitioned in 4 ways:

12 pennies

7 pennies and 1 nickel

2 pennies and 2 nickels

2 pennies and 1 dime

In this example, 12 is the total number of elements (cents) and the denominations allowed are D1=1 cent, D2=5 cents, D3=10 cents, D4=25 cents. Partition problems are a well studied branch of set theory, and there are many variants of the problem which can be posed.

### SUMMARY OF THE INVENTION

The present invention provides a computer-based graphical user interface for partitioning any product. The graphical user interface includes a total element indicator for indicating the total number of elements within the product and a portioning section including one or more sections. Each section includes an indicator for indicating the element size of the section and a control. The control allows a user to select the number of corresponding sections based on the indicated total number of elements and other control positions.

### BRIEF DESCRIPTION OF THE DRAWINGS

The preferred and alternative embodiments of the present invention are described in detail below with reference to the following drawings.

FIG. 1 is the Edit Sections window of the preferred embodiment;

FIG. 2 is a Section Machine window of the preferred embodiment, in the default state;

FIG. 3 is a Section Machine window of the preferred embodiment, with a single 40 page Section selected;

FIG. 4 is a Section Machine window of the preferred embodiment, with three 40 page Sections selected;

FIG. 5 is a Section Machine window of the preferred embodiment, with one 6 page and three 40 page Sections selected;

FIG. 6 is a Section Machine window of the preferred embodiment, with the 6 page Section locked;

FIG. 7 is a Section Machine window of the preferred embodiment, illustrating the final state of the partition resulting from the operations illustrated in the previous figures; and

FIG. 8 is source code animating the user interface and for implementing the functions illustrated in the previous figures. Other code could also be used to implement the user interface of the invention.

### DETAILED DESCRIPTION OF THE PREFERRED EMBODIMENT

The preferred embodiment of the present invention provides a computer interface and underlying software tool to enable a user to efficiently specify a particular partitioning of the many possible partitions possible of N items among an arbitrary set of unit denominations. In the preferred embodiment, the user interface will comprise one or more of the following features or characteristics, or solve partitioning problems under the following conditions:

1) Preferably, the total number of items is known at runtime, but can be any value.

2) Preferably, the allowed denominations are also known at runtime. There can be any arbitrary or pre-determined number of denominations.

3) It is desired for the user to select a single solution to the partitioning problem .

4) It is not necessary for the user to know the total number of possible partitions.

5) It is desired for the user to be informed by the software if at least one partition is possible for a given total number of items and a set of allowed denominations

6) The interface will not allow an impossible number of any particular denomination to be selected, thereby preventing any need for error messages—impossible outcomes are automatically disallowed.

II. Application of Partitioning in a Product

ScenicSoft UpFront® is a preferred embodiment software application that applies the instant invention in the context of the printing industry. Specifically, UpFront® assists with planning how to manufacture a printed product. UpFront® helps the user subdivide the complex series of processes involved in manufacturing a complete printed product into smaller, simpler manufacturing processes.

An example of one such process division is breaking a book's text into sections. A book's text may be a total of 56 pages, but this will be manufactured as smaller folded sections that will finally be bound together to make up the total of 56 pages. Typically, 56 pages of text for a saddle-stitched book (“saddle-stitched” is printing industry jargon for “stapled”) will be made up of the following sections:

1. an 8-page section (pages 1-4 and 53-56)

2. a 16-page section (pages 5-12 and 45-52)

3. a 16-page section (pages 13-20 and 37-44)

4. a 16-page section (pages 21-36)

The determination of the number of sections of each size is an applied example of a partitioning problem: The total number of pages (56) is N, and the section sizes allowed are D1=8 pages and D2=16 pages.

III. Implementation of a Partition User Interface in UpFront®UpFront® version 1.5 offers the user an automatically calculated default for breaking a text page quantity into subsections based on simple business rules. The user can edit the section breakup by means of a single dimensional up/down mechanism which finds the next possible combination of section sizes from the current selection, going either to larger sections or to smaller sections. The dialog window for this purpose is named the Edit Sections window.

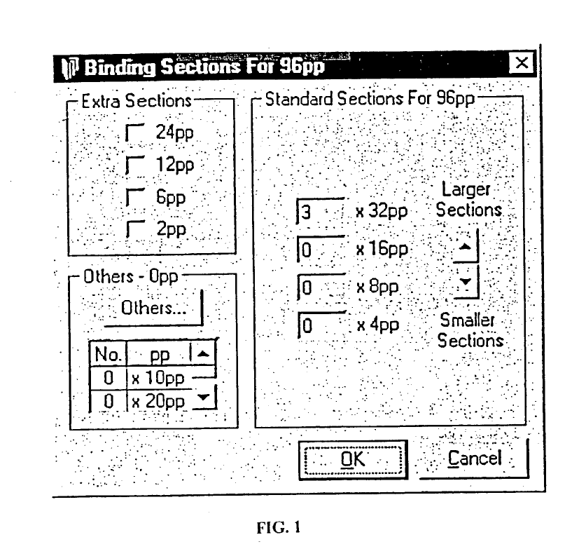

The problem with the Edit Sections window of UpFront version 1.5 (FIG. 1) is that there can be a large number of possible section combinations between the current selection (3 ×32-page pictured below) and the desired selection (for example, 12×8 page sections), requiring the user to scroll down through a large number of iterations to reach the goal. For example, a 256 page book with possible section sizes of 32, 24, 26, 8 and 4 pages has 3396 possible combinations of section sizes. Even this modest number of pages thus presents a problem for users trying to navigate 3396 choices to find the one they want.

Larger size jobs exacerbate the problem to the point where users consider the user interface element unusable: a 1500 page book with those same section size options has 2,382,968 partitions to choose from. Even scrolling through the option at 100 items per second would require over 6 hours to navigate the entire list.

IV. Prototype User Interface for Partition Specification

The present invention therefore provides a more useful user interface strategy for user selection of a partition solution. We have demonstrated feasibility of the technology by building a preferred embodiment prototype. We show examples of this prototype below. Although this prototype is modeled after the real world situation where a total number of pages is partitioned among sections of a certain number of pages, it is implemented to be applicable to any partitioning problem. For example, the section sizes can be completely arbitrary. In this example, the allowed section sizes are 6, 8, 40, 54, 58 and 64 pages. There are no real world situations in which a print planner would want to use these section sizes (if they even exist ). The prototype was done with arbitrary section sizes to substantiate our claim on the application of this technology to any partitioning problem.

A. Contents of the Prototype Window

FIG. 1 shows the prototype in use. The graphical user interface is comprised of a set of controls corresponding to each allowed denomination, and some information about the current state of the partition selection. Referring to FIG. 1, information about the current partition comprises the total number of elements (here, pages). In the example, a control is provided to change the total number of pages. This not required, as the number of elements may be a constant.

B. Responding to User Actions in the Prototype Window: First Slider

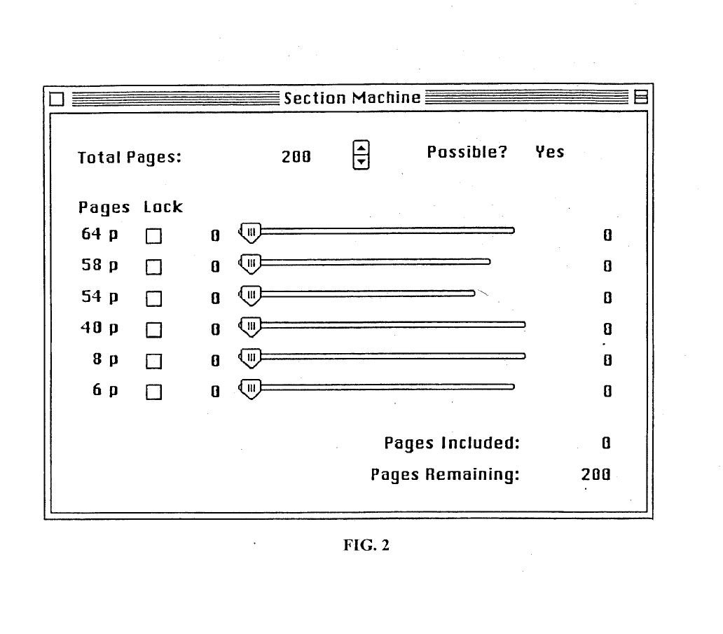

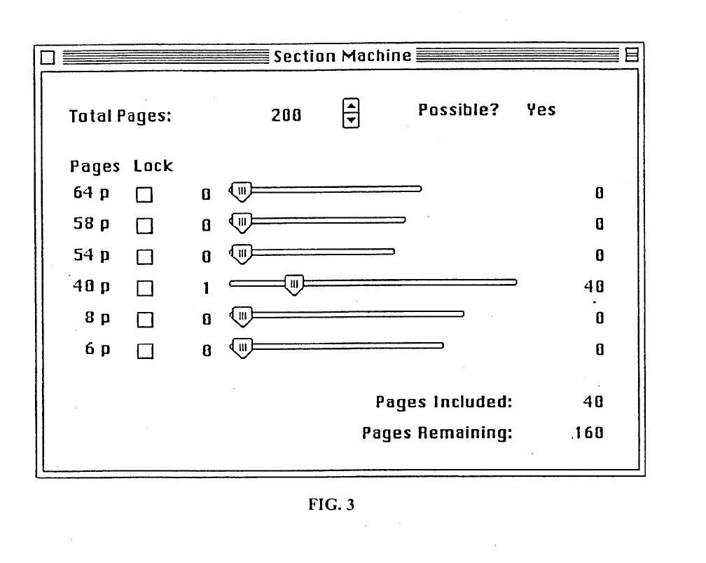

A principal user action in the prototype window is to change the value of the controls for each partition. When this occurs, the allowable range for the other denominations' sliders will change, because the total number of pages remaining will also change. FIG. 2 shows a default screen, with all the sliders set to zero. FIG. 3 shows the change as compared to FIG. 2 when one 40-page section is selected. This change occurs during the dragging of the slider, so that the user is supplied with real-time feedback. The changes that occur in this situation are:

1) The “0” to the left of the slider changes to “1”, indicating that 1 section of that denomination has been chosen.

2) The “0” to the right of the slider changes to “40”, indicating that a total of 40 pages have been allocated to 40-page sections.

3) The “0” after“Pages Included” changes to “40” indicating that the sum of all the pages allocated to sections has increased to 40.

4) The “200” after“Pages Remaining” changes to “160” indicating that this many pages are left to be allocated.

5) The length of the sliders for all the other denominations change. Note that they do not all change the same way. Previously, the maximum value far 6-page sections was

192: it changes to 144 (A reduction of 48). Previously, the maximum value for 8-page sections was 200: it changes to 160 (A reduction of 40).

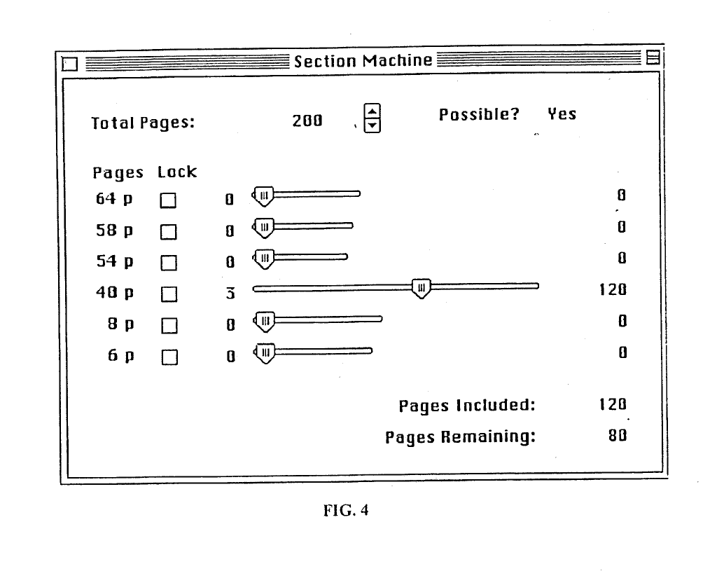

Note that the slider for 6-page sections does not go above 144 pages (24 sections), even though the remaining 160 pages could accommodate 25 or even 26 sections. In these cases the remaining pages could not be partitioned into the available section sizes, so this setting is disallowed. These changes continue during the drag until three 40-page sections are selected, as shown in FIG. 4.

C. Responding to User Actions in the Prototype Window: Second Slider

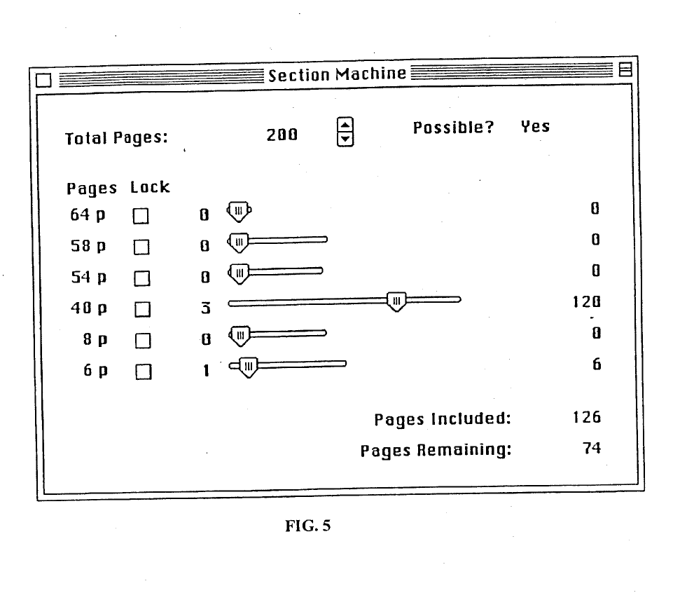

The response to the user action can be more complex. This is illustrated in this example when the value of a second slider is changed. FIG. 5 shows the state of the dialog when one 6-page section is selected in addition to the three 40-page sections. Note that the number after“Pages included” is displaying the correct sum of the pages allocated to various denominations.

Still referring to FIG. 5, also note that the lock check box for the 8-page sections has become disabled, as indicated by the dimming of the rectangle relative to the previous state in FIG. 4, and relative to the other rectangles in FIG. 5. The meaning of disablement is that there are no partitions which include at least one 6-page section, at least three 40-page sections, and exactly 0 8-page sections: i.e. it is now impossible to lock the count of 8-page sections to its current setting of 0. Before the 6-page section was selected (as shown in FIG. 4), there did exist a partition which included at least three 40-page sections and exactly 0 8-page_sections (five 40-page sections ), so the lock box was not disabled.

D. Responding to User Actions in the Prototype Window: Lock box

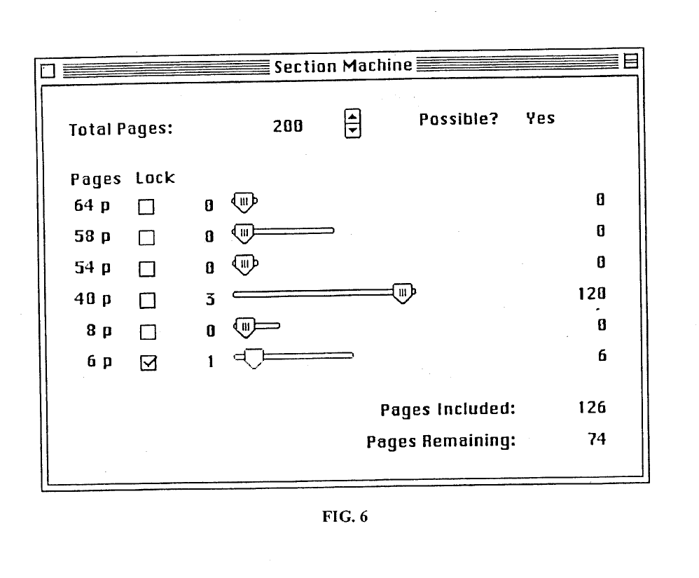

The action of locking the current setting for a particular denomination adds constraints to the partitioning. FIG. 6 shows the state of the dialog after locking the setting of the 6-page sections to 1 section (i.e. 6 pages).

Compared to FIG. 5, the 54-page slider has shrunk so its maximum is zero, the 40 page slider has shrunk so its maximum is 120 pages, the 8-page slider has shrunk so its maximum is 16 pages, and the ‘lock’ option for 58-page sections has disabled. Also, because the 6-page option has been locked, its slider is disabled. The length of the disabled slider reflects what the maximum setting would be if it were turned on.

E. Responding to User Actions in the Prototype Window: Finished

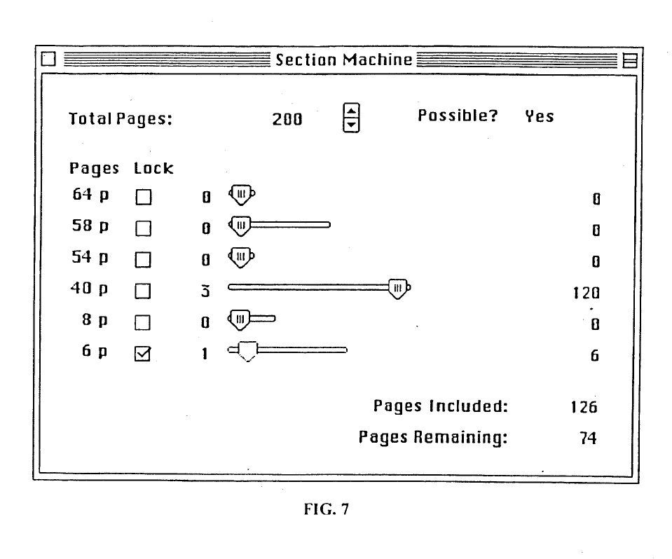

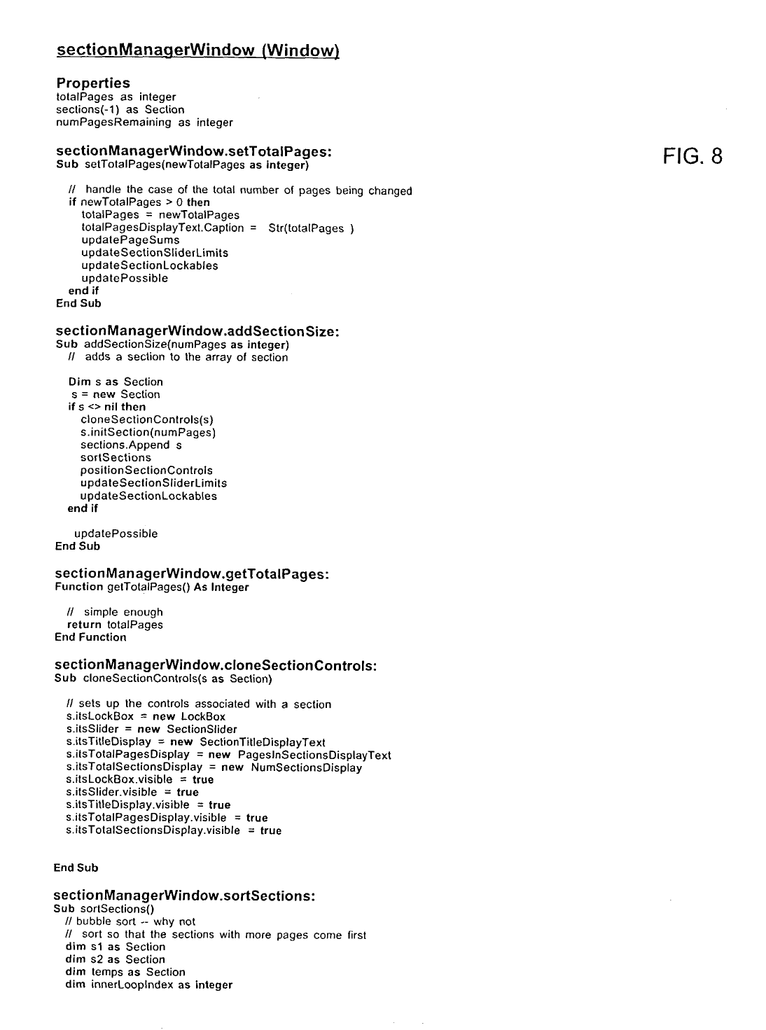

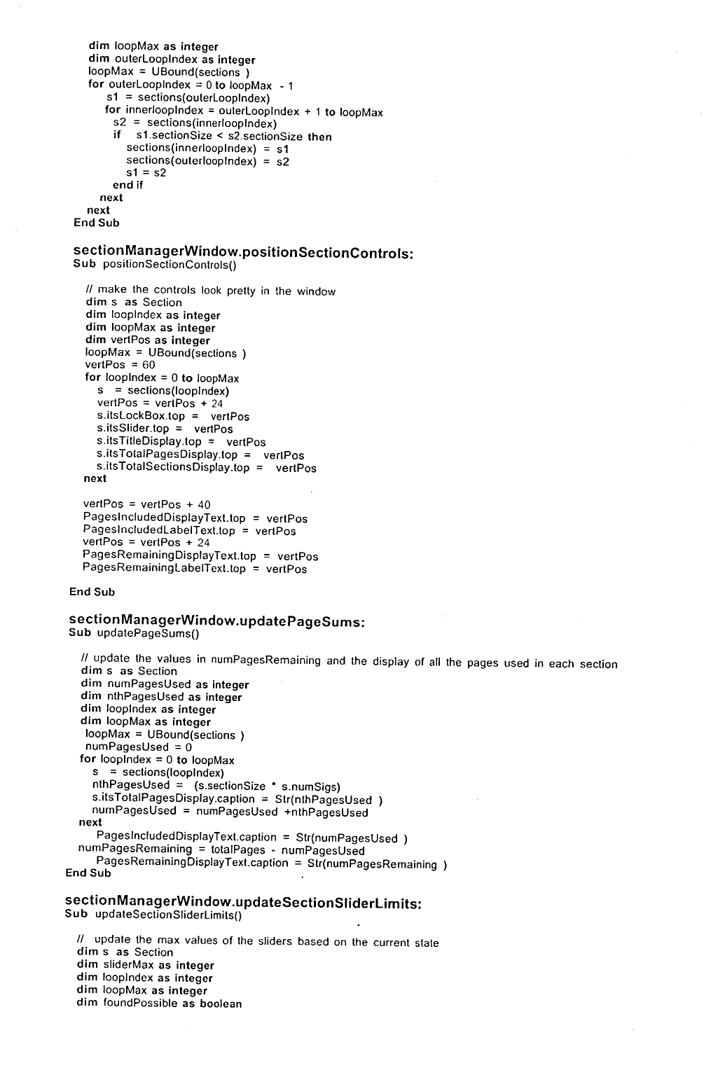

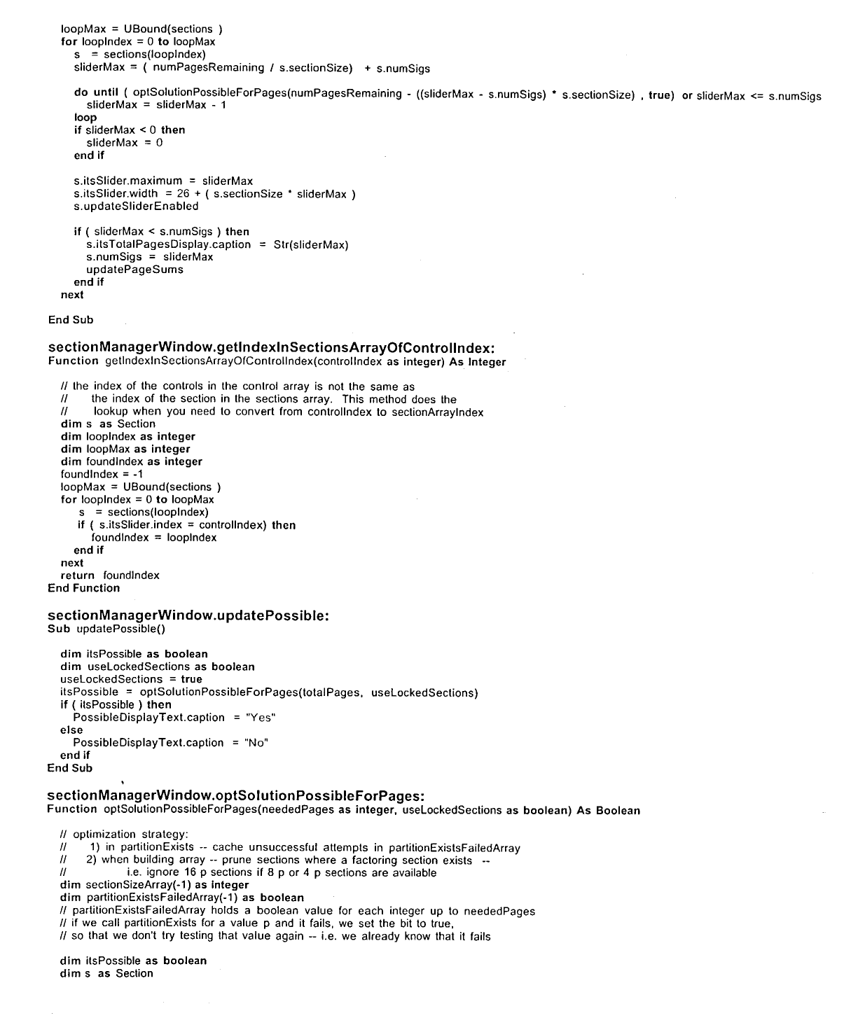

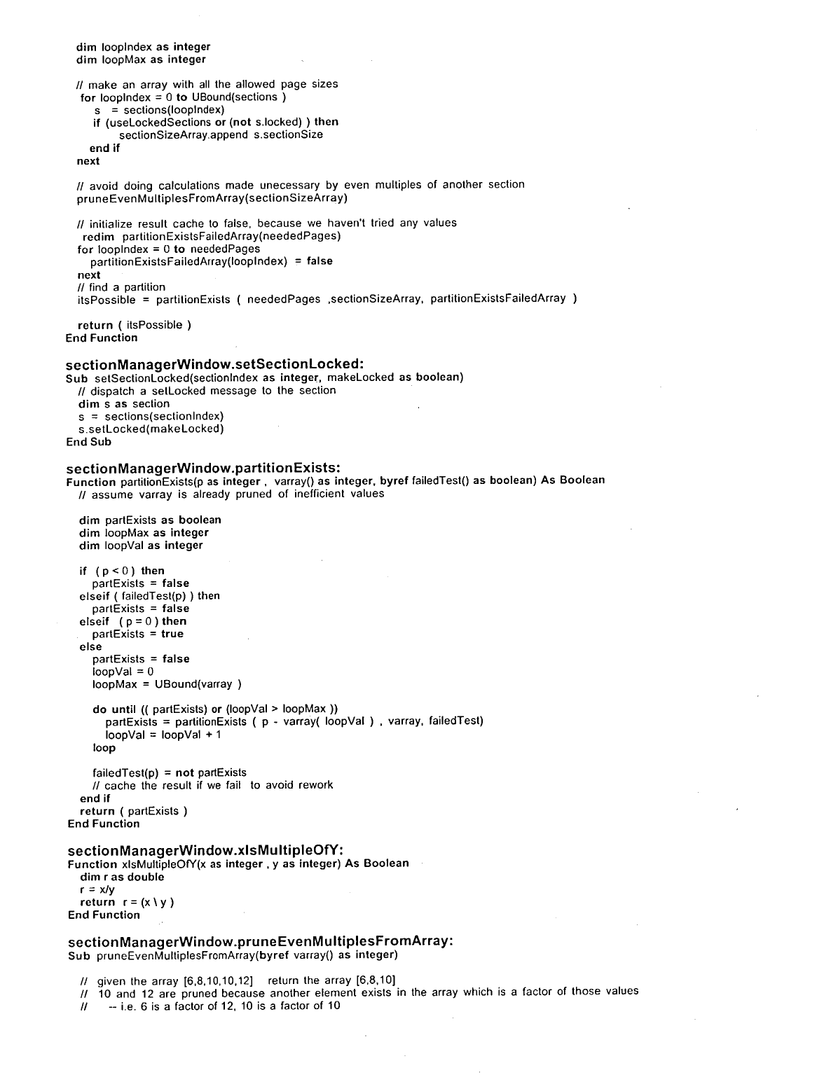

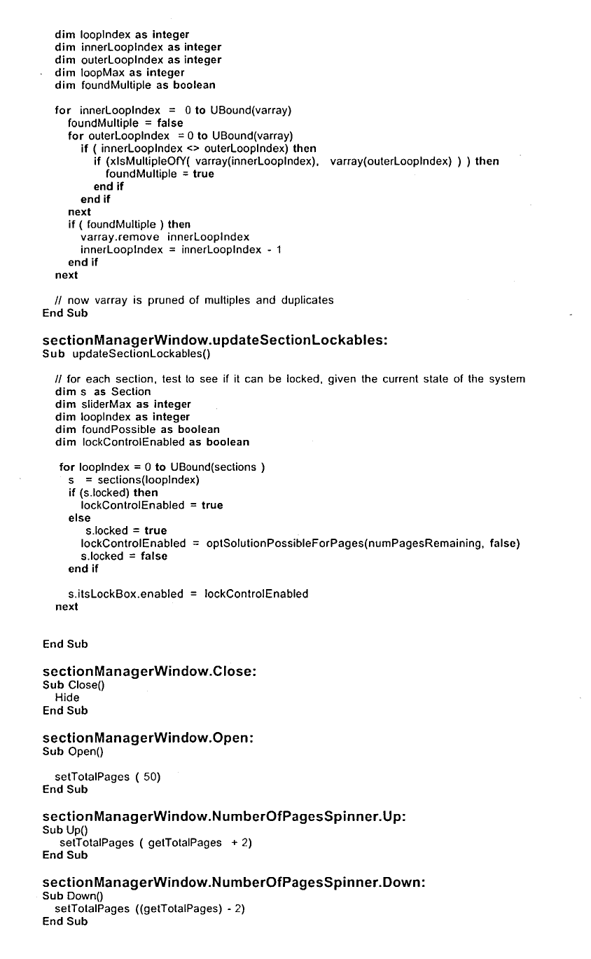

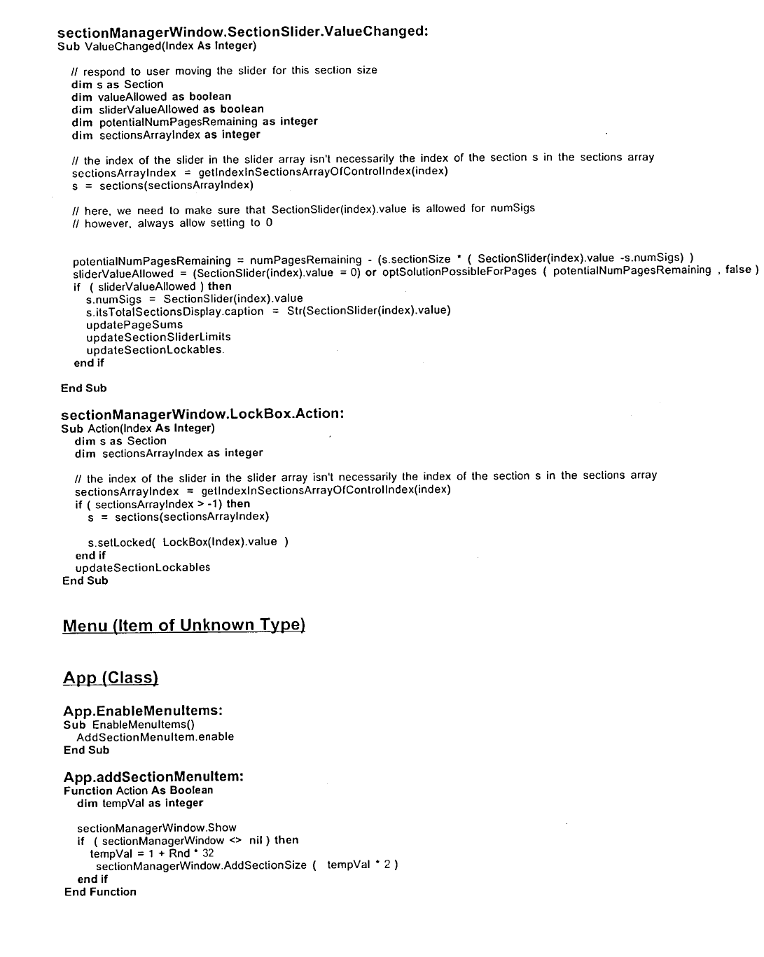

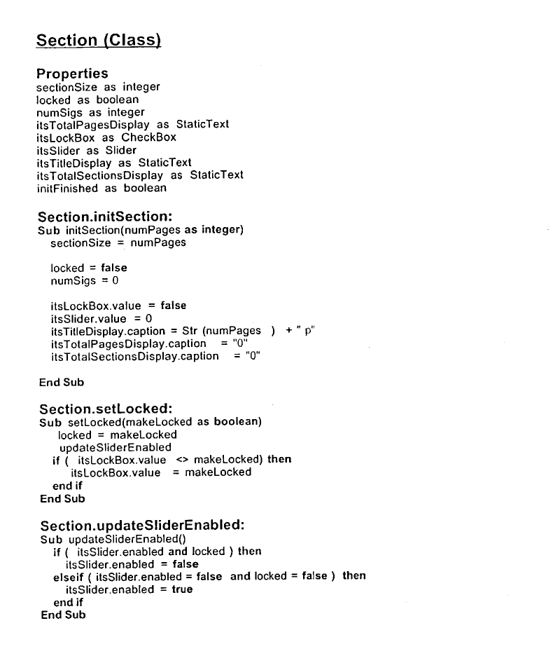

Applying the maximum allowed setting for all the remaining sliders produces a fully partitioned set of 200 pages. This state is shown in FIG. 7. In the preferred embodiment, the user interface never allows an impossible setting to exist, and it always allows the addition of more sections of each denomination if possible. As a user adds sections, constraints are added to the partitioning and gradually fewer possibilities are permitted for completing the partition.

While the preferred embodiment of the invention has been illustrated and described, as noted above, many changes can be made without departing from the spirit and scope of the invention. For example, in the preferred embodiment, the most user-friendly and intuitive control is a slider, but any kind of graphical user interface control (dials, up/down arrows, etc.) can be used without departing from the spirit and scope of the invention. Similarly, the invention is not limited to the printing industry, but can be used anywhere partitioning problems present themselves, especially where underlying combinatorics generate an inconveniently or unmanageably large number of possible outcomes for a user to consider. Accordingly, the scope of the invention is not limited by the disclosure of the preferred embodiment.

The embodiments of the invention in which an exclusive property or privilege is claimed are defined as follows:

1. A computer-based graphical user interface for partitioning a product, the graphical user interface comprising:
a total element indicator for indicating the total amount of elements for the product; and
a portioning section including one or more sections, wherein each section comprises:
an indicator for indicating the element size of the section; and
a control for selecting the number of corresponding sections based on one or more of the following variables: the indicated total number of elements, other control positions, the element size of the section, and any combination of the foregoing variables.

2. The graphical user interface of claim 1, wherein each section further includes component for locking the current control setting.

3. The graphical user interface of claim 1, wherein a maximum value of other control changes in response to setting a new value for one of the controls.

4. The graphical user interface of claim 1, wherein the maximum value of other controls changes during movement of one of the controls.

5. The graphical user interface of claim 1, wherein each section further includes component for locking the current control setting, wherein the locking component is in at least one of an enabled or disabled state and the state is based on the setting of the other sliders.

6. The graphical user interface of claim 5, wherein the state of the locking component changes during operation of a control.

7. The graphical user interface of claim 5, wherein the maximum value of other controls changes in response to locking the value for one of the controls.

8. The graphical user interface of claim 5, wherein the state of the other locking controls changes in response to locking the value for one of the controls.

9. A computer-based method for partitioning a product, the method comprising:
indicating total amount of elements for the product; and
partitioning the product into one or more sections, partitioning comprising:
indicating the element size of the one or more sections; and
selecting the number of corresponding sections using a user interface control based on one or more of the following variables: the indicated total amount of elements, other control user interface positions, the element size of the section, and any combination of the foregoing variables.

10. The method of claim 9, further comprising locking the current user interface control setting.

11. The method of claim 9, further comprising changing a maximum value of other user interface controls in response to setting a new value for one of the controls.

12. The method of claim 9, further comprising changing a maximum value of other user interface controls during movement of one of the user interface controls.

13. The method of claim 9, further comprising:
locking the current user interface control setting; and
setting a state of a user interface control based on the setting of the other user interface controls, wherein the state is one of an enabled or disabled state.

14. The method of claim 13, wherein setting the state includes changing the state during dragging of a user interface control.

15. The method of claim 13, further comprising setting the maximum value of other user interface controls in response to locking the value for one of the user interface controls.

16. The method of claim 13, wherein setting the state includes of other user interface control is based on a locking condition of one of the user interface controls.

17. The graphical user interface of claim 1, wherein the product is a product to be printed.

18. The graphical user interface of claim 1, wherein the control is a slider.

19. The method of claim 9, wherein the product is a product to be printed.

20. The method of claim 9, wherein the control is a slider.
